(19) United States
(12) Patent Application Publication
(10) Pub. No.: US 2020/0396285 A1
(43) Pub. Date: Dec. 17, 2020

(54) CELL PHONE SYNCHRONIZATION SERVER

(71) Applicants: Adam Scheirman, New York, NY (US); Robert Dugan, New York, NY (US); Rayce Stipanovich, New York, NY (US)

(72) Inventors: Adam Scheirman, New York, NY (US); Robert Dugan, New York, NY (US); Rayce Stipanovich, New York, NY (US)

(21) Appl. No.: 16/382,172

(22) Filed: Apr. 11, 2019

Related U.S. Application Data
(60) Provisional application No. 62/656,321, filed on Apr. 11, 2018.

(51) Int. Cl. H04L 29/08; H04W 12/06; G06F 16/27

(52) U.S. Cl. CPC H04L 67/1095; G06F 16/27; H04W 12/06

(57) ABSTRACT

The invention is a solution for providing timing and geosynchronous events to clients attending events with devices capable of receiving synchronization data. Through the use of a distributed computing network client devices send and received event based data which is processed by modules on a time synchronization server and clients and client devices can be authorized as to attendance at events and event data can be sent to the devices for timed geosynchronous playback.

### CROSS REFERENCE TO RELATED APPLICATIONS

This application claims the benefit of provisional application 62/656,321 filed on Apr. 11, 2018.

### REFERENCE TO GOVERNMENT FUNDING SOURCES

Not applicable.

### REFERENCE TO SEQUENCE LISTING

Not applicable.

### FIELDS OF THE INVENTION

The disclosure as detailed herein is in the technical field of data processing servers. More specifically, the present disclosure relates to the technical field of client server management systems.

### GENERAL SUMMARY OF THE INVENTION

The invention is a solution for providing timing and geosynchronous events to clients attending events with devices capable of receiving synchronization data. Through the use of a distributed computing network client devices send and received event based data which is processed by modules on a time synchronization server and clients and client devices can be authorized as to attendance at events and event data can be sent to the devices for timed geosynchronous playback.

### DESCRIPTION OF FIGURES

FIG. 1 is a perspective view, which shows a diagram view which shows an exemplary hardware architecture of a computing device used in an embodiment of the invention.

FIG. 2 is a perspective view, which shows a diagram view which shows an exemplary logical architecture for a client device, according to an embodiment of the invention.

FIG. 3 is a perspective view, which shows a diagram of an exemplary architectural arrangement of clients, servers, and external services, according to an embodiment of the invention.

FIG. 4 is a perspective view, which shows a diagram view which shows an embodiment of a hardware architecture of a computing device used in various embodiments of the invention.

FIG. 5 is a perspective view, which shows the overall use of the system.

FIG. 6 is a diagram of the system determining if a user can participate in an event.

FIG. 7 is a diagram of main use of the system.

FIG. 8 is a diagram of a user signing up for the system.

FIG. 9 is a diagram of client event attendance.

FIG. 10 is a diagram of the administrative use of the system.

FIG. 11 is a diagram of the event happening.

### DETAILED DESCRIPTION

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

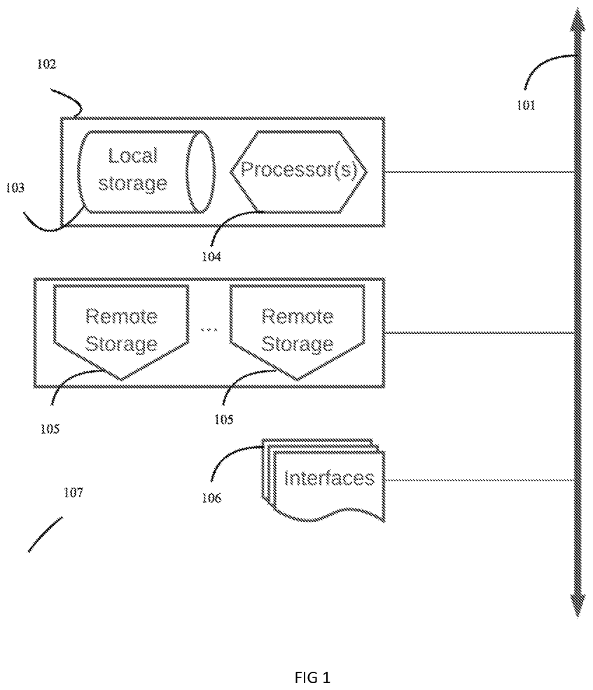

Referring now to FIG. 1, which shows a diagram view which shows an exemplary hardware architecture of a computing device used in an embodiment of the invention.

Communications network 101 comprises a communications network that allows computers to exchange data using known protocols. In some embodiments, it is thought that examples of communications network 101 may include: personal area network, wireless personal area network, near-me area network, local area network, wireless local area network, wireless mesh network, wireless metropolitan area network, wireless wide area network, cellular network, home area network, storage area network, campus area network, backbone area network, metropolitan area network, wide area network, enterprise private network, virtual private network, intranet, extranet, Internetwork, Internet, near field communications, mobile telephone network, CDMA network, GSM cellular networks, or WiFi network. Cpu 102 comprises a unit responsible for implementing specific functions associated with the functions of specifically configured computing device or machine.

The central processing unit is an acronym which stands for cpu 102. In some embodiments, it is thought that examples of cpu 102 may include: system-on-a-chip (SOC) type hardware, Qualcomm SNAPDRAGON™, or Samsung EXYNOS™ CPU. Local memory 103 comprises one or more physical devices used to store programs (sequences of instructions) or data (e g. program state information) on a temporary or permanent basis for use in a computer or other digital electronic device, which may be configured to couple to the system in many different configurations.

In some embodiments, it is thought that examples of local memory 103 may include: non-volatile random access memory (RAM), read-only memory (ROM), or one or more levels of cached memory. Processor 104 comprises a component that performs the instructions and tasks involved in computer processing. In some embodiments, it is thought that examples of processor 104 may include: Intel processor, ARM processor, Qualcomm processor, AMD processor, application-specific integrated circuits (ASICs), electrically erasable programmable read-only memories (EEPROMs), field-programmable gate arrays (FPGAs), mobile processor, microprocessor, microcontroller, microcomputer, programmable logic controller, or programmable circuit.

Remote memory 105 comprises a service that provides users with a system for the backup, storage, and recovery of data. Interface 106 comprises a mechanism to control the sending and receiving of data packets over a computer network or support peripherals used with the computing device 107.

In some embodiments, it is thought that examples of interface 106 may include: network interface cards (NICs), ethernet interfaces, frame relay interfaces, cable interfaces, DSL interfaces, token ring interfaces, graphics interfaces, universal serial bus (USB) interfaces, Serial port interfaces, Ethernet interfaces, FIREWIRE™ interfaces, THUNDERBOLT™ interfaces, PCI interfaces, parallel interfaces, radio frequency (RF) interfaces, BLUETOOTH™ interfaces, near-field communications interfaces, 802.11 (WiFi) interfaces, frame relay interfaces, TCP/IP interfaces, ISDN interfaces, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, or fiber data distributed interfaces (FDDIs). Computing device 107 comprises an electronic device capable of executing software- or hardware-based instructions according to one or more programs stored in memory. In some embodiments, it is thought that examples of computing device 107 may include: desktop computers, carputers, game consoles, laptops, notebooks, palmtop, tablet, smartphones, smartbooks, or a server system utilizing cpu 102, and/or remote memory 105, and interface 106.

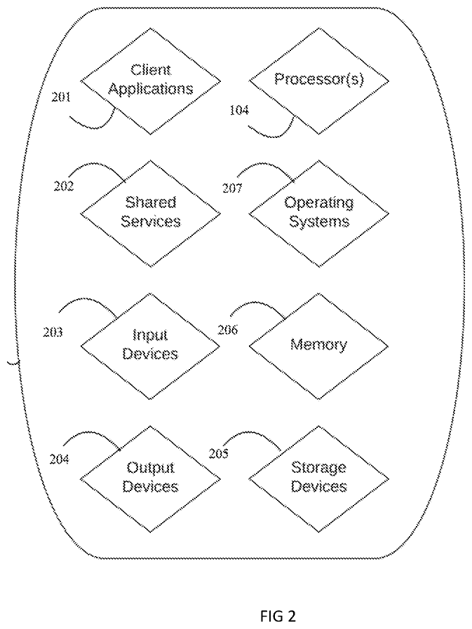

Referring now to FIG. 2, which shows a diagram view which shows an exemplary logical architecture for a client device, according to an embodiment of the invention.

Client application 201 comprises a computing device 107 capable of obtaining information and applications from a server. Shared service 202 comprises web-enabled services or functionality related to a computing device 107. Input devices 203 comprises device of any type suitable for receiving user input. In some embodiments, it is thought that examples of input devices 203 may include: keyboard, touchscreen, microphone, mouse, touchpad, or trackball.

Output devices 204 comprises device of any type suitable for outputting computing device 107 related information. In some embodiments, it is thought that examples of output devices 204 may include: screens for visual output, speakers, or printers. Storage devices 205 comprises mechanism designed to store information which in some embodiments may be memory 206. In some embodiments, it is thought that examples of storage devices 205 may include: magnetic media, hard disks, floppy disks, magnetic tape, optical media, CD-ROM disks, magneto-optical media, optical disks, flash memory, solid state drives (SSD), “hybrid SSD” storage drives, swappable flash memory modules, thumb drives, thumb drives, removable optical storage discs, or electrical storage device.

Memory 206 comprises mechanism designed to store program instructions, state information, and the like for performing various operations described herein, may be storage devices 205, in some embodiments. In some embodiments, it is thought that examples of memory 206 may include: read-only memory (ROM), read-only memory (ROM) devices, memristor memory, random access memory (RAM), or RAM hardware modules. Operating systems 207 comprises system software that manages computer hardware and software resources and provides common services for computer programs. In some embodiments, it is thought that examples of operating systems 207 may include: Microsoft's WINDOWS™ Apple's Mac OS/X, iOS operating systems, Linux operating system, or Google's ANDROID™ operating system.

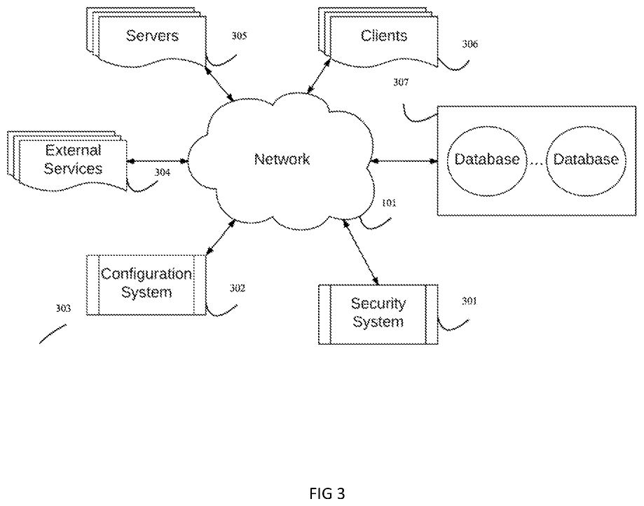

Referring now to FIG. 3, which shows a diagram of an exemplary architectural arrangement of clients, servers, and external services, according to an embodiment of the invention.

Security system 301 comprises a system common to information technology (IT) and web functions that implements security related functions for the system. Configuration system 302 comprises a system common to information technology (IT) and web functions that implements configurations or management system. Distributed computing network 303 comprises any number of Client and/or Server operably connected to a Communications Network for the purposes of implementing the system.

External service 304 comprises web-enabled services or functionality related to or installed on a computing device 107 itself which may be deployed on one or more of a particular enterprise's or user's premises. Server 305 comprises a computing device 107 configured to handle requests received from one or more client 306 over a communications network. Client 306 comprises one or more computing device 107 with program instructions for implementing client-side portions of the present system which in some embodiments, may be connected to a communications network. Database 307 comprises an organized collection of data within a program instructions related system, designed to allow the definition, creation, querying, update, and administration of databases. In some embodiments, it is thought that examples of database 307 may include: relational database system, NoSQL system, Hadoop system, Cassandra system, Google BigTable, column-oriented databases, in-memory databases, or clustered databases.

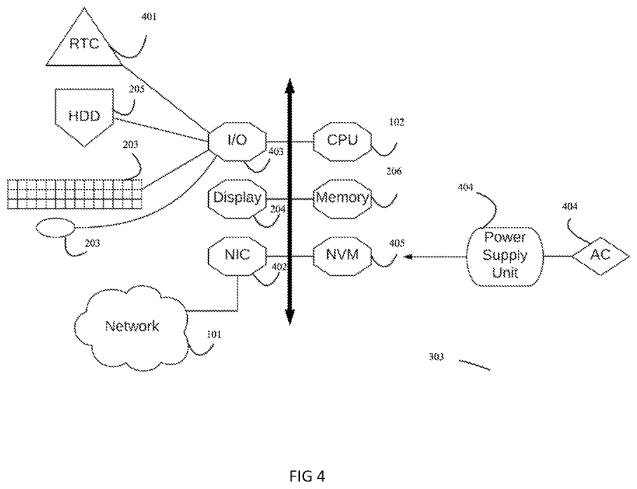

Referring now to FIG. 4, which shows a diagram view which shows an embodiment of a hardware architecture of a computing device used in various embodiments of the invention.

Real time clock 401 comprises a computing device 107 clock (most often in the form of an integrated circuit) that keeps track of the current time. Nic 402 comprises a computer hardware component that connects a computer to a computer network. Input output units 403 comprises devices used by a human (or other system) to communicate with a computer. Power supply 404 comprises an electronic device that supplies electric energy to an electrical load. Non volatile memory 405 comprises computer memory that can retrieve stored information even after having been power cycled (turned off and back on).

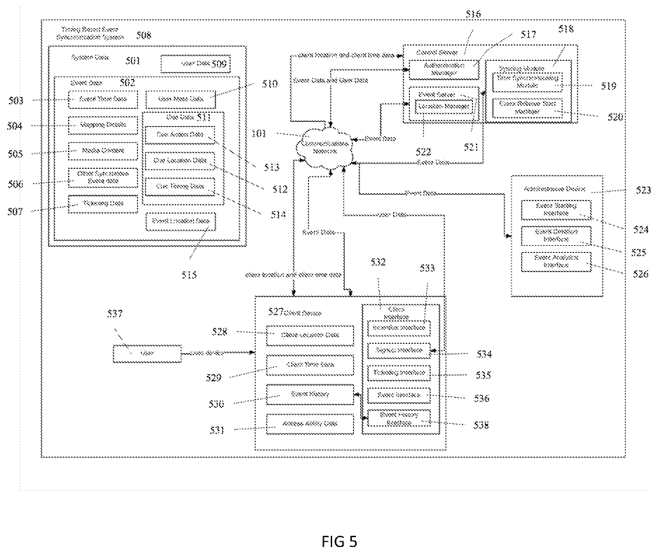

Referring now to FIG. 5, which shows overall use of the system.

System data 501 comprises data or data object which stores information about one or more user 537 and one or more synchronization event. System data 501 comprises event data 502 and user data 509. Event data 502 comprises data or data object which stores information regarding a synchronization event.

Event data 502 preferably comprises event location data 515, event time data 503, media content 505, other synchronous event data 506, user metadata 510, mapping data 504, cue data 511, and finally ticketing data 507.

Event time data 503 comprises data or data object which stores information regarding certain logical points in time. In some embodiments, it is thought that examples of event time data 503 may include: start time, end time, or associated event time.

Mapping data 504 comprises data or data object which stores information regarding the geophysical location of a particular seat at a venue. In some embodiments, it is thought that examples of mapping data 504 may include: arena seat map, map of venue, or geo fencing data.

Media content 505 comprises data or data object which stores information regarding media content that is not associated with a cue data 511. In some embodiments, it is thought that examples of media content 505 may include: media, song, video file, picture, multimedia file, image, or 3d data file. One goal of media content 505 is to allow the timing based event synchronization system 508 to provide extra content or media to users at a time other than during an instance event data 502.

Other synchronous event data 506 comprises data or data object which stores information linking the event data 502 to other instances of event data 502. One goal of other synchronous event data 506 is to enables the timing based event synchronization system 508 to link multiple instances of one or more synchronization event.

Ticketing data 507 comprises data or data object which stores information regarding access to an instance of an event. In some embodiments, it is thought that examples of ticketing data 507 may include: prices, location, duration, date, or access level of ticket. One goal of ticketing data 507 is to enables the timing based event synchronization system 508 to limit access to a synchronization event.

Timing based event synchronization system 508 comprises a system for creating and deploying a synchronized event across multiple devices. Timing based event synchronization system 508 preferably comprises control server 516, client device 527, system data 501, and finally administrative device 523.

User data 509 comprises data or data object which stores information, bibliographic and other metadata regarding one or more user 537 of the timing based event synchronization system 508. One goal of user data 509 is to enable the timing based event synchronization system 508 to track, authenticate and analyze information regarding the individual users of the timing based event synchronization system 508. User data 509 preferably comprises user location data 528.

User metadata 510 comprises information regarding the attendees of the event. In some embodiments, it is thought that examples of user metadata 510 may include: bibliographic, event history, personal preference data related to events of similar types, usage statics, time at event, time at previous events, user location history, or user specific ticketing or access credentials.

Cue data 511 comprises a data or data object that indicates that a client device 527 should perform an instruction at a specific time. One goal of cue data 511 is to enable the timing based event synchronization system 508 to execute actions on one or more client device 527 at certain times. Cue data 511 preferably comprises cue timing data 514, cue location data 512, and finally cue action data 513.

Cue location data 512 comprises data or data object which stores information with respect to the required location of one more client device 527 in order for one or more client device 527 to execute a cue action data 513. In some embodiments, it is thought that examples of cue location data 512 may include: GPS Location, Ticketing Map Information, Time Arrival Based, Auditory Based Location, or network based positioning. One goal of cue location data 512 is to enable the timing based event synchronization system 508 to limit the execution of cue action data 513 based on the location of a client device 527.

Cue action data 513 comprises data or data object which stores information regarding the action which is to be executed on one or more client device 527. In some embodiments, it is thought that examples of cue action data 513 may include: Play Video File, Media File, Turn Phone Light On/Off, Provide Haptic Feedback, Play Audio File, Change Device State, Display Text, change screen color, or play subset of media file.

Cue timing data 514 comprises data or data object which stores information regarding a logical point in time that is associated with a cue data 511. One goal of cue timing data 514 is to enable the timing based event synchronization system 508 to limit the execution of one or more cue action data 513 to certain moments on an event timeline.

Event location data 515 comprises data or data object which stores information regarding the location of a synchronization event. In some embodiments, it is thought that an example of event location data 515 could be GPS Location or perhaps address and the like. One goal of event location data 515 is to enables the timing based event synchronization system 508 to limit and or define the geographical location of an Event.

Control server 516 comprises a module which sends and receives event data 502 via a communications network 101. Control server 516 preferably comprises syncing module 518, event server 521, and finally authentication manager 517.

Authentication manager 517 comprises a module that determines the user devices ability to access and participate in an event data 502. One goal of authentication manager 517 is to enable the timing based event synchronization system 508 to restrict access to a synchronization event.

Syncing module 518 comprises a module which indicates that a synchronization event has begun and communicates to one or more client device 527 via a communications network 101 to indicate the starting and stopping of one or more cue action data 513. Syncing module 518 comprises event relative start manager 520 and time synchronization module 519.

Time synchronization module 519 comprises a module that processes time data to enable the synchronization of an instance of event data 502, client time data 529, and event time data 503. In some embodiments, it is thought that examples of time synchronization module 519 may include: atomic time server, network time server, or local time server.

Event relative start manager 520 comprises a module which calculates the network latency time needed to appropriately sync one or more administrative device 523 and one or more client device 527 to the real-time event. In some embodiments, it is thought that if event relative start manager 520 is absent then the timing based event synchronization system 508 uses an external time server to indicate indicate start event.

Event server 521 comprises a computing device 107 which stores and manages instances of event data 502 and sends and receives instances of event data 502 via a communications network 101 to one or more client device 527 and/or one or more administrative device 523. In some embodiments, it is thought that an example of event server 521 could be cloud based storage of content or perhaps local computing device 107 and the like.

Event server 521 preferably comprises location manager 522. Location manager 522 comprises a module which determines the location of one or more client device 527 in relation to an event location data 515. One goal of location manager 522 is to allow the timing based event synchronization system 508 to determine the relative location of one or more client device 527 in relation to one or more event location data 515. Location manager 522 has an alternative embodiment herein termed auditory location processor embodiment and another termed visual cues are used from the client devices camera embodiment.

Administrative device 523 comprises a computing device 107 which is used by an administrator to create and/or manage an instance of event data 502. Administrative device 523 preferably comprises event creation interface 525, event starting interface 524, and finally event analytics interface 526.

Event starting interface 524 comprises a graphical user interface which enables an administrator to start and/or stop a synchronization event.

Event creation interface 525 comprises a graphical user interface that allows an administrator to create a synchronization event with a non-linear timeline editor. One goal of event creation interface 525 is to allow an administrator to create a synchronization event and assign the relevant event data 502 to it.

Event analytics interface 526 comprises allows the administrator to analyze instances of event data 502 which have occurred in the past or in real time.

Client device 527 comprises a computing device 107 in which a user uses to participate in a synchronization event. Client device 527 preferably comprises client time data 529, access ability data 531, client interface 532, and finally event history data 530.

User location data 528 comprises data or data objet which stores the physical location of the client device 527. In some embodiments, it is thought that examples of user location data 528 may include: Gps location, mapping location, auditory location, wireless network triangulation, or optical based positional data. One goal of user location data 528 is to the sorting of user location data 528 enables the timing based event synchronization system 508 to track and utilize the precise location of the client device 527.

Client time data 529 comprises data or data object storing the local time of the device. One goal of client time data 529 is to enables the timing based event synchronization system 508 to coordinate and synchronize the cue data 511.

Event history data 530 comprises data or data object which stores a cache of the devices event history. Access ability data 531 comprises data or data object which indicates the ability of the client device 527 to access a synchronization event.

Client interface 532 comprises a graphical user interface which enables a user 537 to interact with the timing based event synchronization system 508 and send and receive at least one instance of event data 502. Client interface 532 preferably comprises signup interface 534, event interface 536, incentive interface 533, ticketing interface 535, and finally event history interface 538.

Incentive interface 533 comprises a graphical user interface which sends and receives event data 502 and indicates to a client device 527 that the instant client device 527 is authorized to download additional media content 505.

Signup interface 534 comprises a graphical user interface which enables one or more user 537 to signup for and register to use the timing based event synchronization system 508.

Ticketing interface 535 comprises a graphical user interface which sends and receives ticketing data 507 to the control server 516 via a communications network 101. One goal of ticketing interface 535 is to enable the timing based event synchronization system 508 to limit attendance at an event to certain users who have purchased or otherwise acquired ticketing data 507 for an event.

Event interface 536 comprises a graphical user interface which allows for the display of event data 502 and user data 509.

User 537 comprises one or more persons who attend a synchronization event with a client device 527 using the timing based event synchronization system 508.

Event history interface 538 comprises graphical user interface which permits a user 537 to browse and edit event history data 530.

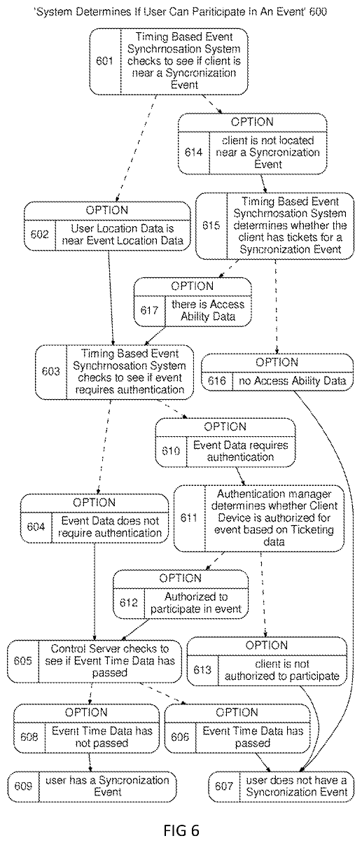

Referring now to FIG. 6, which shows System determines if User Can Participate in an event.

In a first step, timing based event synchronization system 508 checks to see if client is near a synchronization event (Step 601). If user location data 528 is near event location data 515 (Step 602), then timing based event synchronization system 508 checks to see if event requires authentication (Step 603). If event data 502 does not require authentication (Step 604), then control server 516 checks to see if event time data 503 has passed (Step 605). If event time data 503 has passed (Step 606), then user does not have a synchronization event (Step 607). From Step 605, if event time data 503 has not passed (Step 608), then user has a synchronization event (Step 609). From Step 603, if event data 502 requires authentication (Step 610), then authentication manager 517 determines whether client device 527 is authorized for event based on ticketing data 507 (Step 611). If Authorized to participate in event (Step 612), then refer to Step 605. From Step 611, if client is not authorized to participate (Step 613), then refer to Step 607. From Step 601, if client is not located near a synchronization event (Step 614), then timing based event synchronization system 508 determines whether the client has tickets for a synchronization event (Step 615). If no access ability data 531 (Step 616), then refer to Step 607. From Step 615, if there is access ability data 531 (Step 617), then refer to Step 603.

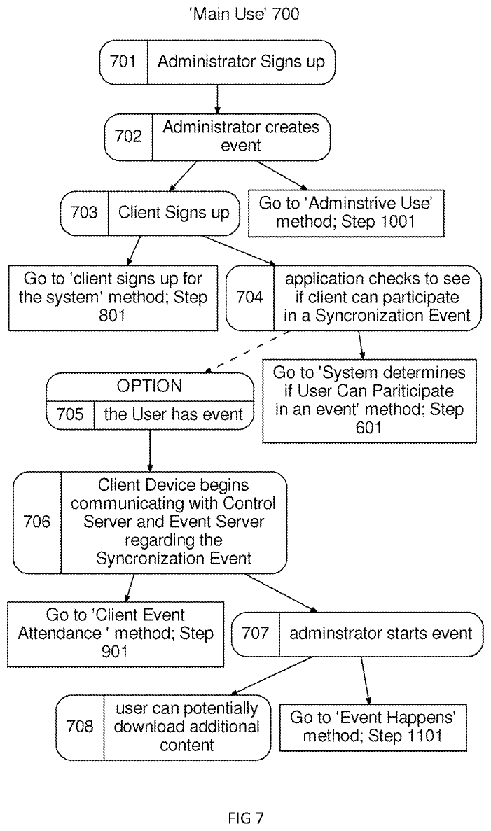

Referring now to FIG. 7, which shows Main use.

In a first step, administrator Signs up (Step 701). Next, Administrator creates event (Step 702). Step 702 is further detailed below in a related method (1000—‘Administrate Use’). Next, Client Signs up (Step 703). Step 703 is further detailed below in a related method (800—‘New Use’). Next, application checks to see if client can participate in a synchronization event (Step 704). Step 704 is further detailed below in a related method (600—‘System determines if User Can Participate in an event’). If the user 537 has event (Step 705), then client device 527 begins communicating with control server 516 and event server 521 regarding the synchronization event (Step 706). Step 706 is further detailed below in a related method (900—‘Client Event Attendance’). Next, administrator starts event (Step 707). Step 707 is further detailed below in a related method (1100—‘Event Happens’). Next, user can potentially download additional content (Step 708).

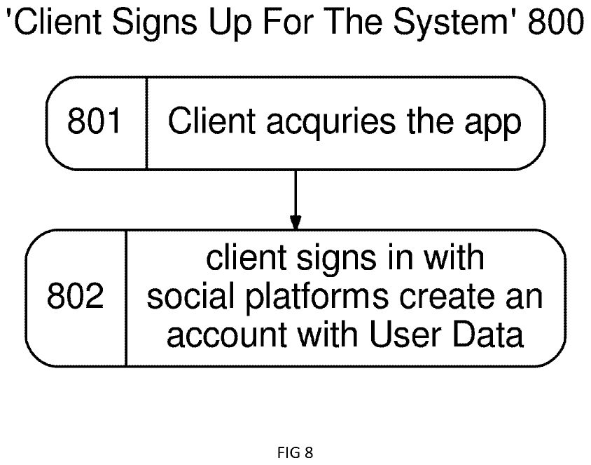

Referring now to FIG. 8, which shows New Use.

In a first step, client acquires the app (Step 801). Next, client signs in with social platforms create an account with user data 509 (Step 802).

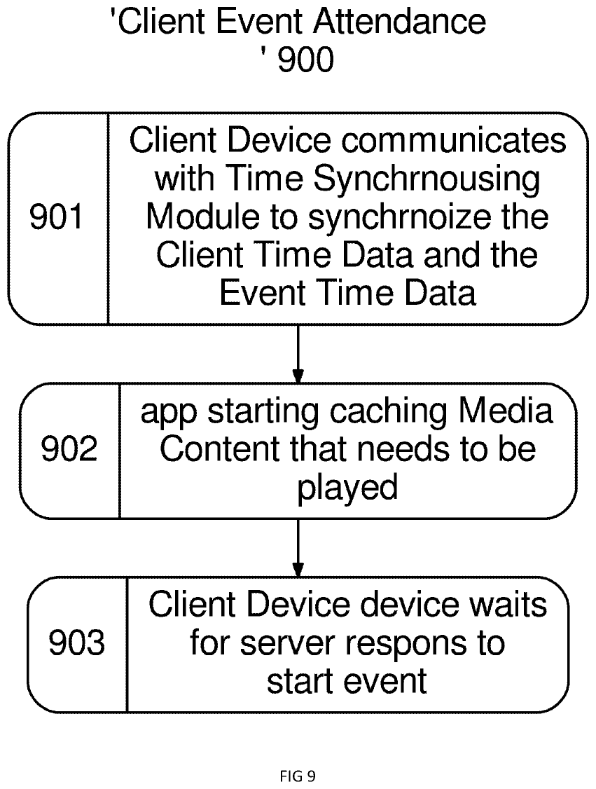

Referring now to FIG. 9, which shows Client Event Attendance.

In a first step, client device 527 communicates with time synchronization module 519 to synchronize the client time data 529 and the event time data 503 (Step 901). Next, app starting caching media content 505 that needs to be played (Step 902). Next, client device 527 device waits for server response to start event (Step 903).

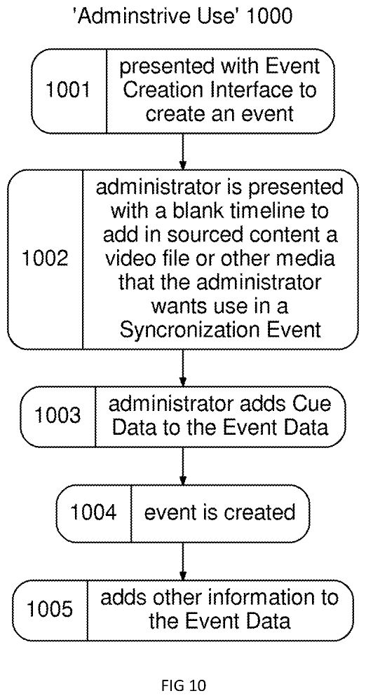

Referring now to FIG. 10, which shows Administrate Use.

In a first step, presented with event creation interface 525 to create an event (Step 1001). Next, administrator is presented with a blank timeline to add in sourced content a video file or other media that the administrator wants use in a synchronization event (Step 1002). Next, administrator adds cue data 511 to the event data 502 (Step 1003). Next, event is created (Step 1004). Next, adds other information to the event data 502 (Step 1005).

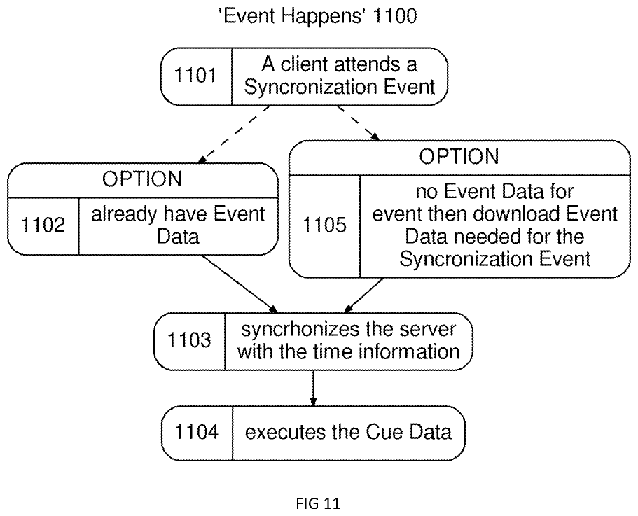

Referring now to FIG. 11, which shows Event Happens.

In a first step, a client attends a synchronization event (Step 1101). If they already have event data 502 (Step 1102), then synchronizes the server with the time information (Step 1103). Next, executes the cue data 511 (Step 1104). From Step 1101, if no event data 502 for event then download event data 502 needed for the synchronization event (Step 1105), then refer to Step 1103.

The following elements and/or terms physical ports, independent processor, interface memory, busses, program instructions, system server, mouse, keyboard, graphical user interface, auditory location processor, synchronization event, administrative account and visual cues are used from the client devices camera are important for the working functionality, but do not appear in the drawings and are shown below.

Physical ports comprises a specialized outlet on a piece of equipment to which a plug or cable connects.

Independent processor comprises a processor 104 that allow communication with with appropriate media. In some embodiments, it is thought that an example of independent processor could be audio processor or perhaps video processor and the like.

In some embodiments, it is thought that examples of interface memory may include: volatile and/or non-volatile memory (e.g., RAM), DDR, DDR2, or GDDR.

Busses comprises a communication system that transfers data between components inside a computer, or between computers.

Program instructions comprises a mechanism for control execution of, or comprise of an operating system, and/or one or more applications. In some embodiments, it is thought that examples of program instructions may include: object code, code produced by a compiler, machine code, code produced by an assembler or a linker, byte code, or code executed using an interpreter.

System server comprises a computing device 107.

Mouse comprises a pointing device that detects two-dimensional motion relative to a surface.

Keyboard comprises a text entry interface to type text and numbers into a word processor, text editor or other programs.

Graphical user interface comprises a type of user interface that allows users to interact with electronic devices through graphical icons and visual indicators such as secondary notation, instead of text-based user interfaces, typed command labels or text navigation.

Auditory location processor comprises a version of the location manager 522 that utilizes the auditory input from a client device 527 to determine the user location data 528 in relation to the event location data 515.

Synchronization event comprises an event which has at least one instance of event data 502 that is participated in by one or more user 537.

Administrative account comprises an account on the server configured for use by an administrator.

Visual cues are used from the client devices camera comprises a version of the location manager 522 where visual pictures are taken from one on more client device 527 to analyze their location based on the visual information contained in the captured images.

What is claimed is:

1. A method for a timing based synchronization system comprising:
a. Checking to see if a client is near a synchronization event;
b. Checking to see if said event requires authentication via an Authentication Manager;
c. Checking to see if said event has event time data and if said event time data has passed.

2. The method of claim 1 further comprising the additional steps of:
a. Said authentication manager determines whether a client device is authorized to participate in an event based on ticketing data before checking to see whether the event time data has passed.

3. The method of claim 2 wherein the timing based synchronization system further comprises:
a. A control server which sends and receives system data via a communication network with an
i. An administrative device; and
ii. Client Device;
b. Wherein the control server further comprises:
i. An authentication manager;
ii. An event server; and
iii. And a syncing module.

4. The method of claim 3 wherein the client device further comprises a client interface wherein the client interface further comprises:
a. An inventive interface;
b. A signup interface;
c. A ticketing interface;
d. An event interface; and
e. An event history interface which displays event history data.

5. A system for a timing based synchronization system comprising:
a. A control server which sends and receives system data via a communication network with an
i. An administrative device; and
ii. Client Device;
b. Wherein the control server further comprises:
i. An authentication manager;
ii. An event server; and
iii. And an syncing module.

6. The system of claim 5 wherein the syncing module sends and receives event data via said communications network.

7. The system of claim 5 wherein the client device further comprises a client interface wherein the client interface further comprises:
a. An inventive interface;
b. A signup interface;
c. A ticketing interface;
d. An event interface; and
e. An event history interface which displays event history data.

8. The system of claim 7 wherein the syncing module further comprises a time synchronizing module and an event relative start manager.

9. The system of claim 8 wherein event data further comprises:
a. Event Time Data;
b. Mapping Details;
c. Media Content;
d. Other Synchronous Event Data;
e. Ticketing Data;
f. User Meta Data;
g. Cue Data, wherein cue data further comprises cue action data, cue location data, cue timing data;
h. Event Location Data.
